(19) United States
(12) Patent Application Publication
(10) Pub. No.: US 2022/0317502 A1
(43) Pub. Date: Oct. 6, 2022

(54) LIQUID CRYSTAL HANDWRITING BOARD AND PREPARATION METHOD

(71) Applicants: Shenzhen PolicralTechnology Co.,Ltd., Shenzhen (CN); Dongguan Sai'en Maker Technology Co., Ltd., Dongguan (CN)

(72) Inventors: Liang Xia, Shenzhen (CN); Longjun Shen, Shenzhen (CN); Rui Shen, Shenzhen (CN)

(21) Appl. No.: 17/711,794

(22) Filed: Apr. 1, 2022

(30) Foreign Application Priority Data
Apr. 1, 2021 (CN) 202110357877.6

(51) Int. Cl. G02F 1/137; G02F 1/1334

(52) U.S. Cl. CPC G02F 1/13718; G02F 1/1334

(57) ABSTRACT

The disclosure provides a liquid crystal handwriting board and a preparation method. The liquid crystal handwriting board successively includes a first substrate, a first conductive layer, a liquid crystal polymer layer, a second conductive layer and a second substrate, wherein a light-resisting component that can resist a specific wavelength is arranged in the first substrate, and the first conductive layer, the second conductive layer and the second substrate are transparent. In the liquid crystal handwriting board of the disclosure, the first substrate and the second substrate are both made of transparent materials, and the light-resisting component is added in the first substrate.

### CROSS REFERENCE TO RELATED APPLICATION(S)

This patent application claims the benefit and priority of Chinese Patent Application No. 202110357877.6, filed on Apr. 1, 2021, the disclosure of which is incorporated by reference herein in its entirety as part of the present application.

### TECHNICAL FIELD

The disclosure relates to a liquid crystal handwriting board, particularly to a liquid crystal handwriting board resisting ultraviolet rays and a preparation method.

### BACKGROUND

A liquid crystal handwriting board, also referred to as a cholesteric liquid crystal writing board, ordinarily includes a first substrate 1, a first conductive layer 2, a liquid crystal polymer layer 3, a second conductive layer 4 and a second substrate 5, wherein the liquid crystal polymer layer contains a bistable cholesteric liquid crystal which can be in transparent and color reflection states. When no pressure acts on the handwriting board, the bistable cholesteric liquid crystal is in a transparent state. When writing is performed on the handwriting board, the bistable cholesteric liquid crystal turns from the transparent state to the color reflection state, thereby reflecting color so as to display the handwriting. To display the handwriting, the first substrate facing a user is often transparent, and the second substrate departing from the user is often brunet, such as black. The first conductive layer and the second conductive layer are in contact with the liquid crystal polymer layer to electrify the liquid crystal polymer layer so that the bistable cholesteric liquid crystal recovers from the color reflection state back to the transparent state, thereby clearing the handwriting on the handwriting board.

The liquid crystal polymer layer in the liquid crystal handwriting board is often formed by UV curing: the bistable cholesteric liquid crystal is mixed with other materials such as a chirality agent, a spacer and a light curing monomer for UV curing, so that the above materials are polymerized to finally form a required liquid crystal polymer layer.

In the use process of the liquid crystal handwriting board, specifically a large-size liquid crystal handwriting board, the liquid crystal polymer layer is affected by ultraviolet rays in sunlight so that substances in the liquid crystal polymer layer are continuously and slowly polymerized and properties of the material change to cause the handwriting is thin, or uncleanness and other problems are cleared. Therefore, the liquid crystal handwriting board needs to be subjected to anti-UV treatment.

The existing anti-UV treatment mainly includes the following manners:

A layer of anti-UV material is coated on a prepared liquid crystal handwriting film (including a first substrate, a first conductive layer, a liquid crystal polymer layer, a second conductive layer and a second substrate), that is, a layer of anti-UV material is coated on the first substrate to form an anti-UV coating. In this way, the UV material is post-coated, which can be limited by the temperature resistance of the liquid crystal polymer layer, and therefore process difficulty is large, and requirements on the anti-UV material is extremely high. In addition, the post-processed anti-UV coating is easy to abrade, and therefore has a general practical application effect.

Another manner is that the mixture material in the liquid crystal polymer layer is changed, and the light-resisting component is added into the material of the liquid crystal polymer layer, so that the cost-effective liquid crystal handwriting board cannot be affected by ultraviolet rays in the environment. However, the formation of the liquid crystal polymer layer usually needs to perform ultraviolet curing (UV curing). Addition of the light-resisting component into the liquid crystal polymer layer can inevitably lead to a slow polymerization reaction so as to greatly prolong the curing time, which is not conducive to industrial production and cost control. Moreover, the addition of the light-resisting component into the liquid crystal polymer layer can also affect the writing effect.

In addition, in the prior art, the second substrate is often brunet, so there are often many dust spots in the large-sized liquid crystal handwriting board due to limitation of materials, causing decrease in quality and reduced in yield.

### SUMMARY

The disclosure is intended to solve the above problems, and provides a liquid crystal handwriting board which can resist ultraviolet rays and control dust spots and a preparation method.

In order to solve the above problems, the disclosure provides a liquid crystal handwriting board, successively comprising a first substrate, a first conductive layer, a liquid crystal polymer layer, a second conductive layer and a second substrate, wherein a light-resisting component that can resist a specific wavelength is arranged in the first substrate, and the first conductive layer, the second conductive layer and the second substrate are transparent.

Further, the liquid crystal handwriting board also comprises a colored background board, which is non-transparent and arranged on the surface of one side of the second substrate opposite to the second conductive layer.

Further, the light-resisting component can resist ultraviolet rays.

Further, the light-resisting component can resist infrared rays.

Further, the first substrate is transparent.

Further, the colored background layer is provided with patterns.

Further, the haze of the first substrate is 1%-90%.

In addition, the disclosure provides a method for preparing a liquid crystal handwriting board, comprising the following steps:

S1, forming a transparent first conductive layer on the surface of one side of a first substrate, wherein a light-resisting component that can resist a specific wavelength is arranged in the first substrate;

S2, forming a second conductive layer on the surface of one side of a transparent second substrate;

S3, coating a liquid crystal mixed material between the first conductive layer and the second conductive layer; and

S4, performing ultraviolet irradiation on the liquid crystal mixed material from one side of the second substrate far away from the first substrate so that the liquid crystal mixed material is polymerized to form a liquid crystal polymer layer combined with the first conductive layer and the second conductive layer.

Further, after the liquid crystal mixed material is polymerized to form the liquid polymer layer, the method also comprises:

S5, forming a colored background layer on the surface of one side of the second substrate far away from the first substrate.

Further, the intensity of ultraviolet irradiation is 0.1 mW/cm²-20 mW/cm², and the time of ultraviolet irradiation is 0.5 min-20 min.

The disclosure has the beneficial effects that the above problems are effectively solved. In the liquid crystal handwriting board of the disclosure, the first substrate and the second substrate are both made of transparent materials, and the first substrate is added with the light-resisting component that can filter and absorb a light with a specific wavelength of sunlight is added in the first substrate. In the process of preparation, the conventional UV curing method changes and UV irradiation is conducted from the second substrate side, so that the UV curing step is not affected by the light-resisting component in the first substrate, the UV curing time of the liquid crystal polymer layer is not prolonged, and the prepared liquid crystal handwriting board also has an anti-UV effect. In addition, the first substrate and the second substrate are both made of transparent materials, which can also control the dust spots of the material itself so as to improve product quality and production yield.

### BRIEF DESCRIPTION OF THE DRAWINGS

FIG. 1 is a block diagram of a structure according to the disclosure.

FIG. 2 is a block diagram of another structure according to the disclosure.

### DESCRIPTION OF THE EMBODIMENTS

The following embodiments will further explain and supplement the disclosure, but not limit the disclosure.

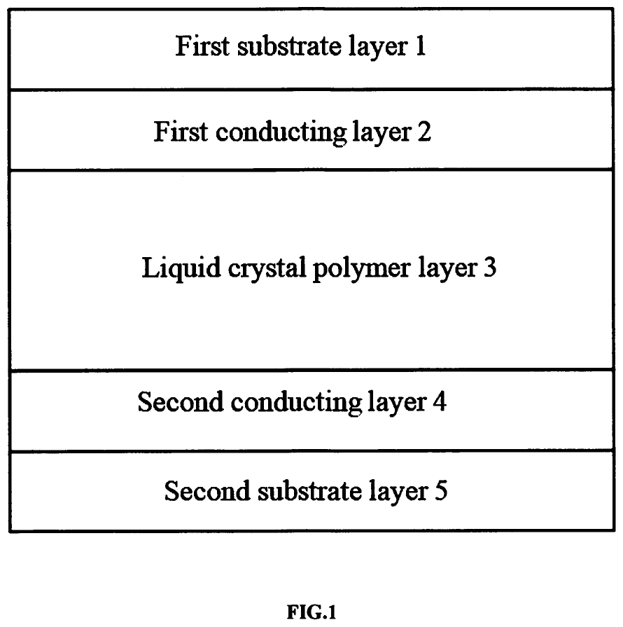

As shown in FIG. 1, a liquid crystal handwriting board of the disclosure includes a first substrate 1, a second conductive layer 4, a liquid crystal polymer layer 3, a second conductive layer 4 and a second substrate 5.

The first substrate 1 is transparent, and is internally provided with a light-resisting component. The light-resisting component can filter and absorb a light with a specific wavelength of sunlight. For example, the light-resisting component can filter and absorb UV light and has an anti-ultraviolet ability. For example again, the light-resisting component can filter and absorb a part of infrared wavelength light and has an anti-infrared ability. The specific types of the light-resisting components can be selected as required. For example, when it is needed to realize the anti-ultraviolet ability, the light-resisting component can select titanium dioxide, zinc oxide or other components. The content of the light-resisting component can be set according to the application environment of the liquid crystal handwriting board, and is not limited in this example. When the ultraviolet intensity in the main application environment is relatively high, the content of the light-resisting component for resisting ultraviolet rays can be appropriately improved.

The light-resisting component can be a single-component substance or a multi-component substance. For example, the light-resisting component can select a component for resisting ultraviolet rays, such as titanium dioxide, or can select multiple components for resisting ultraviolet rays, such as titanium dioxide and zinc oxide; or can select multiple components for resisting ultraviolet rays and infrared rays, which can be specifically selected as required.

In this example, the first substrate 1 selects an optical-grade PET material which has a haze of 1%-90% and a surface scrap-resisting degree of 1H-6H. Through a well-known process, a PET film with a light-resisting component inside can be machined as the first substrate 1 of the disclosure.

In other examples, the first substrate 1 can also be made of other flexible and transparent materials inside which the light-resisting components can be added through the well-known process.

The second conductive layer 4 is transparent, which is attached to the first substrate 1. The second conductive layer 4 is formed by coating or sputtering a conductive material on the first substrate 1. The conductive material of the second conductive layer 4 can be selected based on a well-known technology, such as an indium tin oxide (ITO) conductive material and a metal conductive material.

The materials of the liquid crystal polymer layer 3 can refer to the well-known technology, which include a bistable cholesteric liquid crystal, a polymer monomer, a photoinitiator, a chiral agent and other substances. The liquid crystal polymer layer 3 can be formed by UV curing.

The second conductive layer 4 is transparent, which is attached to the second substrate 5. The second conductive layer 4 is formed by coating or sputtering a conductive material on the second substrate 5. The conductive material of the second conductive layer 4 can be selected based on a well-known technology, such as an ITO conductive material and a metal conductive material. The conductive material of the second conductive layer 4 can be the same as or different from that of the first conductive layer 2, which can be specifically set as required.

The second substrate 5 is transparent and comprises no light-resisting component inside. The second substrate 5 can select a well-known transparent film material, such as an optical-grade PET film material and transparent glass.

A transparent handwriting film can be formed by the first substrate 1, the first conductive layer 2, the liquid crystal polymer layer 3, the second conductive layer 4 and the second substrate 5.

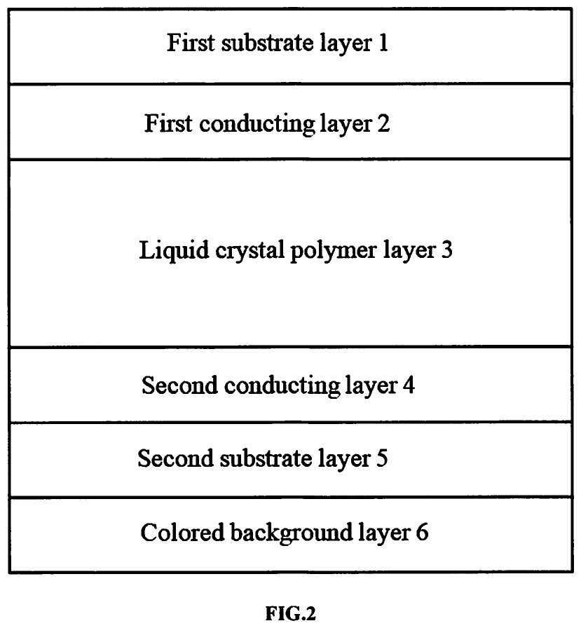

Further, as shown in FIG. 2, the liquid crystal handwriting board can also include a colored background layer 6. The colored background layer 6 is non-transparent, which is compounded on the surface of one side of the second substrate 5 opposite to the second conductive layer 4 and used for comparing with a color reflected by the bistable cholesteric liquid crystal so that the handwriting is more clearly displayed. The color of the colored background layer 6 can be set as required, for example, it can be set as a conventional black, a gradient color combined with multiple colors, etc.

Further, patterns can also be set on the colored background layer 6. For example, transverse lines, matts and other patterns can be set, so as to facilitate users to write neatly or conduct position reference. For example again, dot matrix patterns can be set for coordinate orientation so that a smart liquid crystal handwriting board is formed.

Since the light-resisting component is added in the first substrate 1, in the practical use, influence of specific wavelength lights such as ultraviolet wavelength in the environment can be effectively resisted, thereby avoiding that the liquid crystal polymer layer 3 is affected by ultraviolet rays to be denatured, and then maintaining the properties of the product and improving the service life of the product. Furthermore, since the light-resisting component is added inside the first substrate 1 but not compounded on the surface of the first substrate 1, the first substrate 1 is still integrally molded. Thus, the surface hardness of the product can still be effectively maintained, and the light-resisting component can take effects all the time without being abraded, thereby significantly improving the surface property and the anti-UV property of the product. Besides, since the first substrate 1 and the second substrate 5 are both transparent, the dust spots of the raw material itself can be effectively controlled during the machining, so as to improve the quality and yield of the product.

A method for preparing a liquid crystal handwriting board includes the following steps:

S1, forming a transparent first conductive layer 2 on the surface of one side of the first substrate 1, wherein a light-resisting component that can resist a specific wavelength is arranged in the first substrate 1;

S2, forming a second conductive layer 4 on the surface of one side of a transparent second substrate 5;

S3, coating a liquid crystal mixed material between the first conductive layer 2 and a second conductive layer 4; and

S4, performing ultraviolet irradiation on the liquid crystal mixed material from one side of the second substrate 5 far away from the first substrate 1 so that the liquid crystal mixed material is polymerized to form a liquid crystal polymer layer 3 combined with the first conductive layer 2 and the second conductive layer 4.

The above steps S1 and S2 can be in no order.

In step S1, the machining process of the first substrate 1 referred to the well-known technology. For this example, the well-known first substrate 1 added with the light-resisting component was selected for step S1. For example, the anti-UV optical PET film was selected as the first substrate 1, and then the first conductive layer 2 was formed on the PET film. For example again, the anti-UV and anti-infrared optical PET film was selected as the first substrate 1, and then the first conductive layer 2 was formed on the PET film.

In step S2, the second substrate 5 selected a well-known transparent material, for example, an optical PET film, and a UV component was not contained inside the optical PET film.

In steps S1 and S2, the formation process of the first conductive layer 2 and the second conductive layer 4 referred to the well-known technology, and was not limited by this example. For example, an ITO conductive material was coated on the surfaces of one sides of the first substrate I and the second substrate 5 to form the first conductive layer 2 and the second conductive layer 4.

In step S3, the preparation of the liquid crystal mixed material referred to the well-known technology, and was not limited by this example.

In step S4, the intensity of ultraviolet irradiation was 0.1 mW/cm²-20 mW/cm², and the irradiation time was 0.5 min-20 min. In this example, the irradiation intensity was preferably 10 mW/cm², and the irradiation time was preferably 8 min. The liquid crystal mixed material was irradiated from one side of the second substrate 5 so that the UV curing of the liquid crystal polymer layer 3 was not affected by the light-resisting component in the first substrate 1 so as not to prolong the UV curing time.

After step S4, the liquid crystal mixed material was cured into the liquid crystal polymer layer 3 so that the first substrate, the first conductive layer 2, the liquid crystal polymer layer 3, the second conductive layer 4 and the second substrate 5 were combined into a whole so as to form a preliminary handwriting film.

Further, after step S4, the method of the disclosure also includes the following step:

S5, forming a colored background layer 6 on the surface of one side of the second substrate 5 far away from the first substrate 1.

In step S5, the colored background layer 6 can be formed by means of multiple manners. For example, in some examples, colored paint can be coated on the surface of the second substrate 5 to form the colored background layer 6.

In this example, the handwriting film and the background board were adhered with colored AB glue, such as black AB glue, so that the colored background layer 6, namely, a background board and colored AB glue, was formed at one side of the second substrate 5. The background board was transparent, or non-transparent and colorful. Since the AB glue was colorful, the colored background layer 6 was still formed at the outer side of the second substrate 5. In other examples, the handwriting film and the non-transparent background board were adhered with glue so that the colored background layer 6 is formed at one side of the second substrate 5.

The color of the colored background layer 6 is not limited. When the colored background layer is brunet, the display effect of the handwriting can be improved. The colored background layer 6 can be in a single-layer structure, or a composite structure, which is not limited by this example.

Although the disclosure is described by the above embodiments, the scope of the disclosure is not limited thereto. The above components can be replaced with similar or equivalent elements known by those skilled in the art without departing from the concept of the disclosure.

What is claimed is:

1. A liquid crystal handwriting board, successively comprising a first substrate (1), a first conductive layer (2), a liquid crystal polymer layer (3), a second conductive layer (4) and a second substrate (5), wherein a light-resisting component that can resist a specific wavelength is arranged in the first substrate (1), and the first conductive layer (2), and the second conductive layer (4) and the second substrate (5) are transparent.

2. The liquid crystal handwriting board according to claim 1, further comprising:
a colored background board (6), which is non-transparent and arranged on the surface of one side of the second substrate (5) opposite to the second conductive layer (4).

3. The liquid crystal handwriting board according to claim 1, wherein the light-resisting component can resist ultraviolet rays.

4. The liquid crystal handwriting board according to claim 1, wherein the light-resisting component can resist infrared rays.

5. The liquid crystal handwriting board according to claim 1, wherein the first substrate (1) is transparent.

6. The liquid crystal handwriting board according to claim 2, wherein the colored background layer (6) is provided with patterns.

7. The liquid crystal handwriting board according to claim 1, wherein the haze of the first substrate (1) is 1%-90%.

8. A method for preparing a liquid crystal handwriting board, comprising the following steps:
S1, forming a transparent first conductive layer (2) on the surface of one side of a first substrate (1), wherein a light-resisting component that can resist a specific wavelength is arranged in the first substrate (1);
S2, forming a second conductive layer (4) on the surface of one side of a transparent second substrate (5);
S3, coating a liquid crystal mixed material between the first conductive layer (2) and a second conductive layer (4); and
S4, performing ultraviolet irradiation on the liquid crystal mixed material from one side of the second substrate (5) far away from the first substrate (1) so that the liquid crystal mixed material is polymerized to form a liquid crystal polymer layer (3) combined with the first conductive layer (2) and the second conductive layer (4).

9. The method for preparing a liquid crystal handwriting board according to claim 8, wherein after the liquid crystal mixed material is polymerized to form the liquid polymer layer (3), the method further comprises:
S5, forming a colored background layer (6) on the surface of one side of the second substrate (5) far away from the first substrate (1).

10. The method for preparing a liquid crystal handwriting board according to claim 8, wherein the intensity of ultraviolet irradiation is 0.1 mW/cm²-20 mW/cm², and the time of ultraviolet irradiation is 0.5 min-20 min.
